(19) United States
(12) Patent Application Publication
(10) Pub. No.: US 2007/0047623 A1
(43) Pub. Date: Mar. 1, 2007

(54) Method and apparatus for generating a pseudorandom binary sequence using a linear feedback shift register

(76) Inventors: Yoo-Chang Eun, Seoul (KR); Seung-Chul Hong, Seoul (KR); Jong-Han Lim, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/511,505

(22) Filed: Aug. 29, 2006

(30) Foreign Application Priority Data
Aug. 30, 2005 (KR) 2005-80387

(51) Int. Cl. H04B 1/00

(52) U.S. Cl. 375/130

(57) ABSTRACT

A method and apparatus are provided for generating a code by quickly computing a state of a Linear Feedback Shift Register (LFSR) in a mobile communication system, in which a code for the communication system is generated including an n-stage LFSR and operating in sleep mode and active mode set at a preset time interval from the sleep mode. Current state values of the LFSR are combined with n different mask patterns such that the current state values are shifted by {2⁰,2¹, . . . ,2ⁿ⁻¹}. A combination result is provided as a new state value of the LFSR at an arbitrary time variably set in the sleep mode. To transform a current state value of the LFSR to a new state value after an arbitrary time, the code generation method employs a square and multiply algorithm without use of mask patterns.

### CROSS-REFERENCE TO RELATED PATENT APPLICATIONS

This application claims the benefit under 35 U.S.C. § 119(a) to a Korean Patent Application filed in the Korean Intellectual Property Office on Aug. 30, 2005 and assigned Serial No. 2005-80387, the entire disclosure of which is hereby incorporated by reference.

### BACKGROUND OF THE INVENTION

1. Field of the Invention

The present invention generally relates to a Linear Feedback Shift Register (LFSR). More particularly, the present invention relates to a method and apparatus for quickly computing a state of an LFSR to generate a code in a mobile communication system.

2. Description of the Related Art

A Linear Feedback Shift Register (LFSR) is a circuit for generating a pseudorandom binary sequence corresponding to a sequenced binary bit stream using linear feedback. In this circuit, values of multiple shift registers are shifted one by one in a clock period. Also, an input of a shift register is applied by performing an Exclusive-OR (EXOR) operation on some outputs. The LFSR is applied to a Pseudo Noise (PN) generator of Code Division Multiple Access (CDMA) mobile communication systems such as cdma2000 or Universal Mobile Telecommunication Systems (UMTS).

Various technologies are being applied to reduce power consumption of a terminal of the CDMA system. The typical technology is an operation in sleep mode. A method for reducing power consumption also in the sleep mode is being considered. A clock for operating the LFSR configuring the PN generator is supplied from a Temperature Compensated Crystal Oscillator (TCXO) conventionally operating at a high rate. When the TCXO is operated at a low rate and power of the LFSR is interrupted in the sleep mode, the power consumption can be reduced. For example, when a high-speed 42-stage LFSR operating at 1.2288 Mchips/sec generates a long PN code in a cdma2000 1× system, power of the LFSR is interrupted and the elapsed time is counted using a low-speed clock rather than a high-speed clock in the sleep mode. A method has been proposed which can compute a state of the LFSR to be used after wake-up by employing a mask pattern for advancing the state of the LFSR by the number of chips corresponding to the sleep time if the terminal repeats sleep and wake-up operations in a fixed period.

FIGS. 1 and 2 illustrate devices for computing a state of the LFSR to be used after wake-up in the sleep mode using a fixed mask pattern when the LFSR has a regular wake-up period in the sleep mode. FIG. 1 is a block diagram illustrating an example of a device for computing a state in a conventional PN generator. This device computes a state of a 4-stage LFSR in a Fibonacci connection scheme.

Referring to FIG. 1, the device extracts a current LFSR state using a given mask pattern and computes a state after a time mapped to the mask pattern. For this operation, the device stores desired state values in buffers R₃, R₂, R₁ and R₀ by 4-chip advancing in a state in which SW1 and SW2 are closed and SW3 is opened. Then, registers S₃, S₂, S₁ and S₀ are sequentially filled with R₃, R₂, R₁ and R₀ values from a 5^{th} chip to an 8^{th} chip in a state in which SW1 and SW2 are opened and SW3 is closed. A method for serially inputting R₃, R₂, R₁ and R₀ values to the registers S₃, S₂, S₁ and S₀ has been described. Alternatively, the values can be simultaneously input in parallel. Because the registers S₃, S₂, S₁ and S₀ are filled with desired state values after the 8^{th} chip, the LFSR can operate normally in a state in which only SW1 is closed.

When the device of FIG. 1 is extended, a desired LFSR state can be computed after {2n} chips have elapsed with respect to an n-stage LFSR. Assuming that the device is operated at a chip rate of the LFSR and the LFSR is awakened after T chips from the start point of the sleep mode, the device is started with a T-chip advance mask pattern at a point of time of {T-2n} chips. Assuming that the device operates at more than a chip rate only in a LFSR state computation interval and its required time is×(<2n) chips, the device is started after {T-x} chips from the start point of the sleep mode.

FIG. 2 is a block diagram illustrating another example of a conventional device for computing a state of the PN generator. This device computes a state of a 4-stage LFSR in a Galois connection scheme.

Referring to FIG. 2, the device computes R₃, R₂, R₁ and R₀ values like the device of FIG. 1, computes R′₃, R′₂, R′₁ and R′₀ values by linearly combining the R₃, R₂, R₁ and R₀ values, and sequentially fills registers S₃, S₂, S₁ and S₀ of the LFSR with the R′₃, R′₂, R′₁ and R′₀ values. A method for serially inputting the R′₃, R′₂, R′₁ and R′₀ values to the registers S₃, S₂, S₁ and S₀ has been described. When the R′₃, R′₂, R′₁ and R′₀ values are input in parallel, proper linear combinations of the R₃, R₂, R₁ and R₀ values corresponding to the R′₃, R′₂, R′₁ and R′₀ values can be directly input to the registers S₃, S₂, S₁ and S₀.

FIG. 3 is a flowchart illustrating a processing operation for computing a state of an n-stage LFSR after an arbitrary time of t (=tₙ₋₁ tₙ₋₂ t₀)₂) chips rather than a fixed time from the start point of the sleep mode (Steps 31-39), which is different from those of the conventional devices of FIGS. 1 and 2. In this processing operation, a multiply operation can be directly used in a finite field GF(2ⁿ).

Referring to FIG. 3, a LFSR state of the Galois connection scheme is mapped to an element β of GF(2ⁿ) at the start point of the sleep mode (Step 33). At this time, β is multiplied by α′ where α is a primitive element. A multiply operation result is demapped to the LFSR state, such that a desired result can be obtained (Step 39). At this time, α² in the range of 0≦i≦n−1 is pre-stored and used in a table without directly computing α′ to reduce a computation amount (Step 31). Then, α² written to the table is cumulatively multiplied by β only when tᵢ is 1 while i is incremented by 1 without computing βα′ (Step 36).

A searcher or finger of the CDMA system performs a slew operation for multipath combining or handover. FIG. 4 illustrates a conventional concept of the slew operation using an increase/decrease in a clock. This operation computes a new state after the elapsed time in place of the current state of the PN generator.

Referring to FIG. 4, the clock speed of the PN generator is reduced to ½ of the clock speed of the normal state when a PN sequence is retarded on a PN circle indicating one period of the PN sequence. When the sequence is advanced, the clock speed of the PN generator becomes twice that of the normal state.

As described above, the conventional art has the following problems.

When the wake-up occurs at a regular time interval in the sleep mode, the devices of FIGS. 1 and 2 are simple and effective. As illustrated in FIG. 5, power of the LFSR and a high-speed clock for operating the LFSR is interrupted in the sleep mode. A low-speed counter counts the elapsed time in a unit of k chips. At this time, it is assumed that a pre-stored mask pattern can generate states after T/4, T/2, 3T/4 and T chips from the current LFSR state. When T is sufficiently large and a user interrupt occurs between T/4 chips and T/2 chips, the next computable LFSR state closest to the user interrupt is a state in T/2 chips. A standby time of about δ chips is required from a point of time when the user interrupt has occurred to a point of time when the next state can be computed. To remove this standby time, all (T/k) mask patterns should be stored up to T chips with respect to all multiples of k chips and a state after the elapsed time should be computed. A problem exists in the conventional art in which a memory requires a large capacity when all necessary mask patterns are stored.

On the other hand, when a processing operation for computing a state after an arbitrary time as illustrated in FIG. 3 is implemented with software, a delay occurs due to computation and data read/write operations. A problem exists in which a very complex operation logic is required if the processing operation is implemented with hardware.

As described above, the slew operation computes a new LFSR state after the elapsed time. This operation can retard or advance the LFSR by adjusting the speed of a clock for operating the LFSR. In this case, a time required for the slew operation is proportional to a slew amount. A problem exists in which a chip clock mapped to a half of a PN sequence period is required if chip clocks used for the retard and advance operations are half and twice the normal clock, respectively.

Accordingly, there is a need for an improved method and apparatus for reducing computation of a PN generator in an sleep/idle mode and reducing power consumption of a terminal and improving the reception of the terminal

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a method and apparatus that can quickly and efficiently generate a code by quickly and efficiently computing a new state of a Linear Feedback Shift Register (LFSR) used for a code generator in a mobile communication system.

It is another aspect of exemplary embodiments of the present invention to provide a method and apparatus that can simplify hardware operation logic when computing a state of a LFSR used for a code generator in a mobile communication system.

It is yet another aspect of exemplary embodiments of the present invention to provide a method and apparatus that can reduce power consumption and can also improve signal acquisition performance by reducing the number of clocks and a required time when computing a state of a LFSR used for a code generator in a mobile communication system.

In accordance with an aspect of exemplary embodiments of the present invention, there is provided a method for generating a code for a communication system using an n-stage Linear Feedback Shift Register (LFSR), in which a characteristic polynomial indicative of current state values of the LFSR is expressed by elements of a finite Galois field; the characteristic polynomial is expressed by a function of a primitive element of the Galois field; a characteristic polynomial at an arbitrary time variably set from the characteristic polynomial expressed is computed by the function of the primitive element; and a multiply operation and a square operation on the characteristic polynomial computed are repeated at the arbitrary time and a code with a new state value is generated by providing the new state value of the LFSR.

In accordance with another aspect of exemplary embodiments of the present invention, there is provided a method for generating a code for a communication system comprising an n-stage Linear Feedback Shift Register (LFSR) and operating in sleep mode and active mode set at a preset time interval from the sleep mode, in which current state values of the LFSR and n different mask patterns are combined to shift the current state values by {2⁰,2¹, . . . ,2ⁿ⁻¹}; and a combination result as a new state value of the LFSR is provided at an arbitrary time variably set in the sleep mode.

In accordance with a further aspect of exemplary embodiments of the present invention, there is provided a computer-readable medium storing computer-readable codes for performing a method for generating a code for a communication system comprising an n-stage Linear Feedback Shift Register (LFSR),

The foregoing has outlined rather broadly the features and technical advantages of exemplary embodiments of the present invention so that those skilled in the art may better understand the detailed description of the invention that follows.

Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

### BRIEF DESCRIPTION OF THE DRAWINGS

The above and other objects, features, and advantages of certain exemplary embodiments of the present invention will be more apparent from the following detailed description taken in conjunction with the accompanying drawings, in which:

FIG. 1 is a block diagram illustrating an example of a conventional device for computing a state of a Pseudo Noise (PN) generator;

FIG. 2 is a block diagram illustrating another example of a conventional device for computing a state of the PN generator;

FIG. 3 is a flowchart illustrating a conventional processing operation for computing a state of the PN generator;

FIG. 4 illustrates a concept of a conventional slew operation;

FIG. 5 is a signal timing diagram illustrating a problem occurring in the conventional processing operation for computing a state of the PN generator;

FIG. 6 is a block diagram illustrating an example of a device for computing a state of a PN generator in accordance with an exemplary embodiment of the present invention;

FIG. 7 is a flowchart illustrating an example of a processing operation for computing a state in the device of FIG. 6;

FIG. 8 is a block diagram illustrating another example of a device for computing a state of a PN generator in accordance with an exemplary embodiment of the present invention;

FIG. 9 is a flowchart illustrating an example of a processing operation for computing a state in the device of FIG. 8;

FIG. 10 is a flowchart illustrating another example of a processing operation for computing a state of the PN generator in accordance with an exemplary embodiment of the present invention;

FIGS. 11A and 11B illustrate shift register logic structures for performing a multiply operation and a square operation in the processing operation of FIG. 10;

FIG. 12 is a block diagram illustrating a device for computing a sate of the PN generator in accordance with an exemplary embodiment of the present invention;

FIG. 13 is a signal timing diagram illustrating an operation for computing a state in the device of FIG. 12; and

FIGS. 14 to 16 illustrate linear combination functions fed back to shift registers when a square operation is performed in the device of FIG. 12.

Throughout the drawings, the same drawing reference numerals will be understood to refer to the same elements, features and structures.

### DETAILED DESCRIPTION OF EXEMPLARY EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The present invention proposes a new algorithm and hardware structure for quickly computing a state of a Linear Feedback Shift Register (LFSR) used for a Pseudo Noise (PN) code generator in a mobile communication system. As described with reference to the conventional art, the present invention can be divided into two exemplary implementations. In a first exemplary implementation, a terminal of a Code Division Multiple Access (CDMA) system is awakened at a regular time interval after stopping the PN generator to reduce power consumption in sleep mode. In a second exemplary implementation, a searcher or finger of the CDMA system quickly slews the PN generator, operating at a chip rate for multipath combining or handover, by the arbitrary number of chips. A difference between the exemplary implementations is present. However, both exemplary implementations follow the same technical idea of computing a new state after the elapsed time in place of the current state of the PN generator.

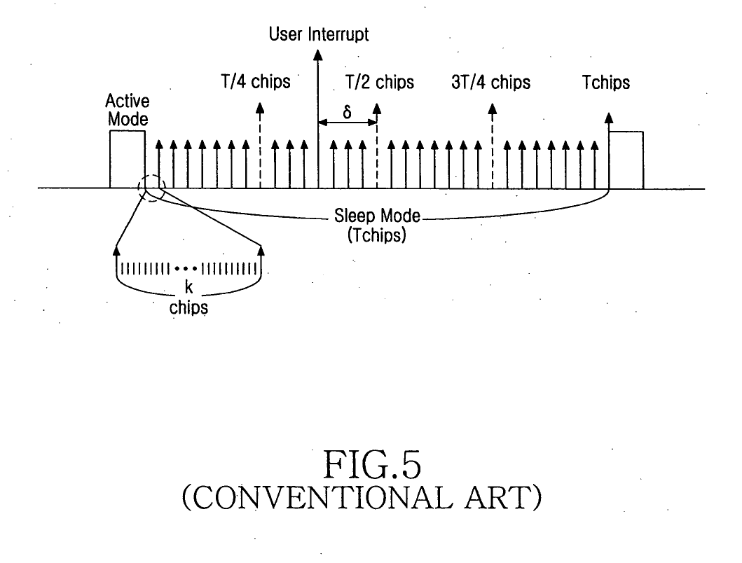

As described with reference to FIG. 5, the terminal of the CDMA system should be able to be awakened at an arbitrary time in response to a user's request without waiting for up to a fixed time interval from the beginning of the sleep mode. Thus, a LFSR state should be quickly recovered at an arbitrary point of time. Accordingly, exemplary embodiments of the present invention propose a method and apparatus for computing the LFSR state after an arbitrary time has elapsed in the sleep mode by repeatedly applying a mask pattern. That is, exemplary embodiments of the present invention proposes a method and apparatus for computing the LFSR state after an arbitrary elapsed time by repeatedly applying n mask patterns in the case of an n-stage LFSR by improving the conventional scheme using a mask pattern with respect to a fixed elapsed time.

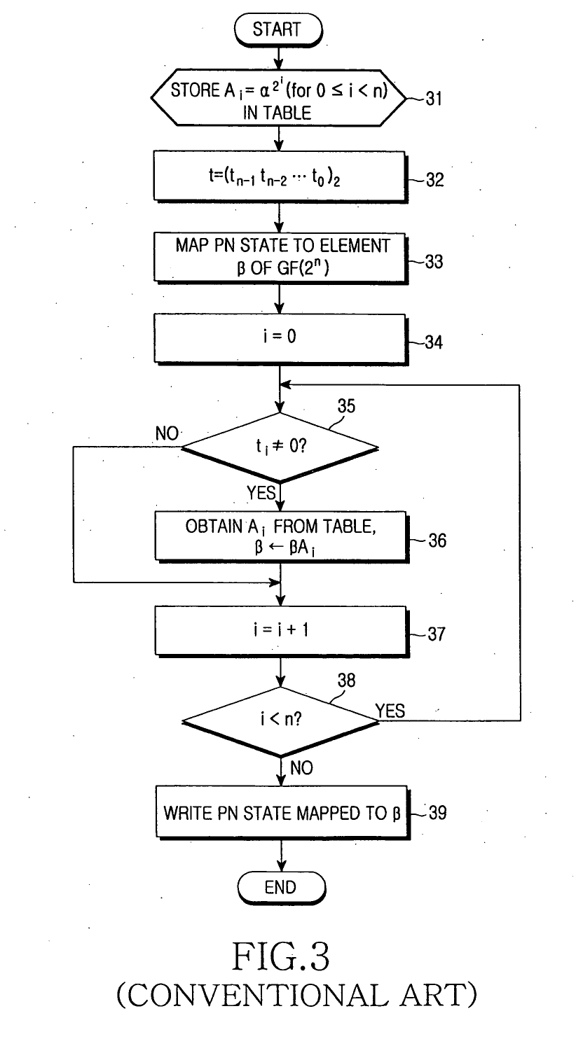

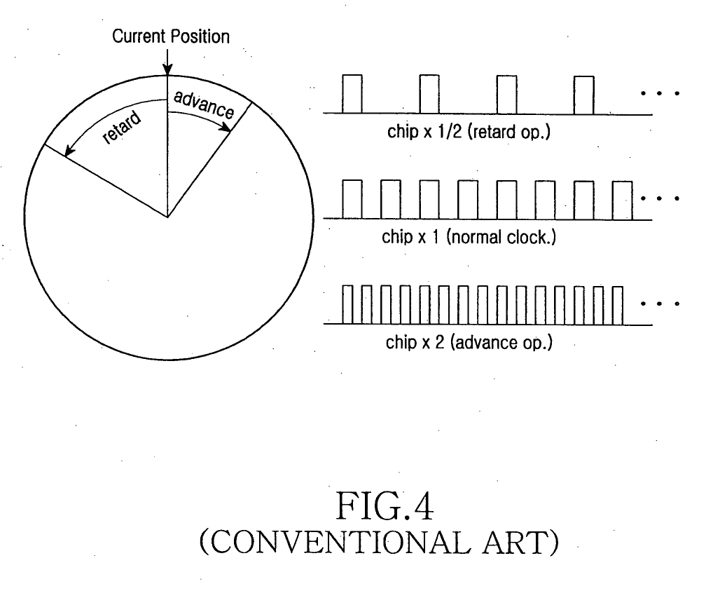

As described with reference to FIG. 4, the slew operation of the searcher or finger of the CDMA system changes the current state of the PN generator to a new state after an arbitrary time has elapsed. A high-speed slew operation is required to increase a standby time of the terminal or to improve synchronization acquisition performance in relation to the sleep mode or handover. The present invention proposes a new square & multiply algorithm for improving a direct computation scheme as illustrated in FIG. 3 and shortening an operation time to a 2n-chip time without referring to a memory and a slew device implemented by the new square & multiply algorithm. According to the proposed algorithm, the time reduction of the slew operation enables high-speed operations of a searcher and finger assignment and can reduce power consumption by reducing an operation time of the terminal in sleep/idle mode.

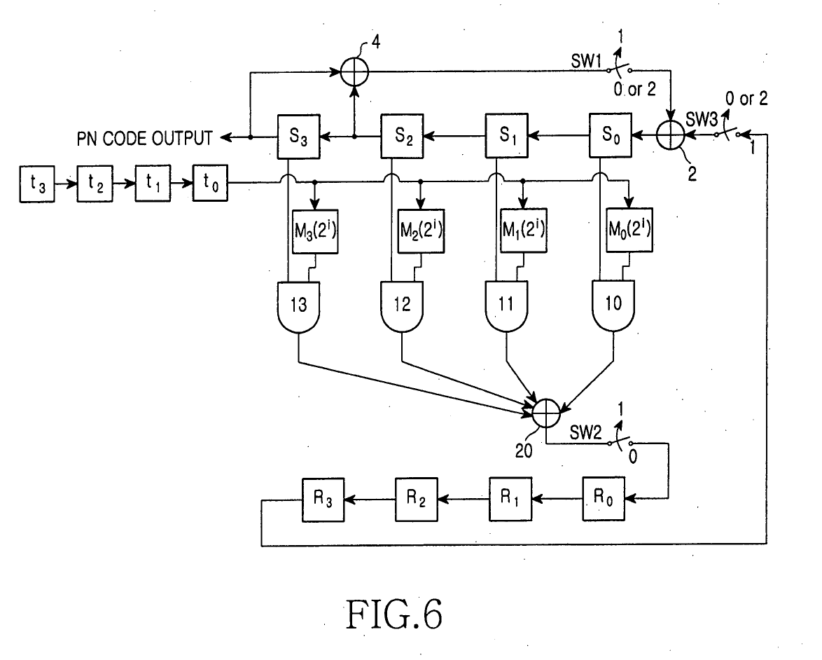

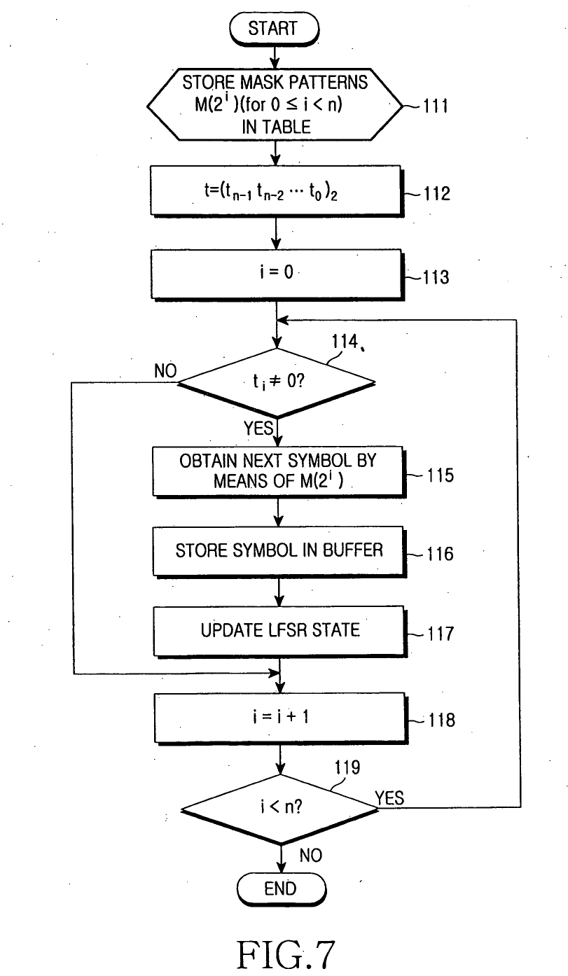

FIG. 6 is a block diagram illustrating an example of a device for computing a state of a PN generator in accordance with an exemplary embodiment of the present invention and FIG. 7 is a flowchart illustrating an example of a processing operation for computing a state in the device of FIG. 6. In FIG. 6, the device computes a state after an arbitrary time has elapsed by successively applying at most 4 mask patterns to a 4-stage LFSR of a Fibonacci connection scheme. FIG. 7 illustrates an extension of the device of FIG. 6. FIG. 7 is the flowchart illustrating the processing operation for computing a state after an arbitrary time has elapsed by successively applying at most n mask patterns to an n-stage LFSR.

Referring to FIG. 6, the LFSR of the PN generator is provided with shift registers S₀, S₁, S₂, and S₃ and Exclusive-OR (EXOR) operators 2 and 4. Except for these components, the remaining components configure the device for computing a state of the PN generator.

The shift register S₀ receives an output of the EXOR operator 2 and then outputs a shifted value. The shift register S₁ receives the output of the shift register S0 and then outputs a shifted value. The shift register S₂ receives the output of the shift register S₁ and then outputs a shifted value. The shift register S₃ receives the output of the shift register S₂ and then outputs a shifted value. The output of the shift register S₃ is a PN code output. The EXOR operator 4 receives the values output from the shift registers S₂ and S₃, performs an EXOR operation on the received values, and outputs an EXOR operation result. The output of the EXOR operator 4 is provided to one input terminal of the EXOR operator 2 through a switch SW1. The EXOR operator 2 receives the output of the EXOR operator 4, receives an output of a buffer R₃ through a switch SW3, and performs an EXOR operation on them to output an EXOR operation result. AND operators 10˜13 receive the outputs of the shift registers S₀˜S₃ and mask patterns M₀˜M₃ mapped thereto, perform AND operations on them, and output AND operation results. The AND operator 10 receives the output of the shift register S₀ and the mask pattern M0 and performs the AND operation on S₀ and M₀ values. The AND operator 11 receives the output of the shift register S₁ and the mask pattern M₁ and performs the AND operation on S₁ and M₁ values. The AND operator 12 receives the output of the shift register S₂ and the mask pattern M₂ and performs the AND operation on S₂ and M₂ values. The AND operator 13 receives the output of the shift register S₃ and the mask pattern M₃ and performs the AND operation on S₃ and M₃ values. An EXOR operator 20 receives values output from the AND operators 10˜13, performs an EXOR operation on them, and outputs an EXOR operation result. A buffer R₀ buffers the output of the EXOR operator 20 received through a switch SW2. A buffer R₁ receives and buffers an output of the buffer R₀. A buffer R₂ receives and buffers an output of the buffer R1. A buffer R3 receives and buffers an output of the buffer R₂. An output of the buffer R₃ is provided to one input terminal of the EXOR operator 2 through the switch SW3. State values output from the buffers R₃, R₂, R₁, and R₀ are serially provided to the shift registers S₃, S₂, S₁, and S₀ of the LFSR.

At the time of an initial operation, the switches SW1 and SW2 are closed and the switch SW3 is opened. When a preset time for example, 4 chips) has elapsed, the switches SW1 and SW2 are switched to the opening state and the switch SW3 is switched to the closing state. When a preset time (for example, 8 chips) has elapsed, the switches SW1 and SW2 are switched to the closing state and the switch SW3 is switched to the opening state. This switching operation is repeated in a set time unit.

As a result, the mask patterns M(2⁰) (=M₀(2⁰)M₁(2⁰)M₂(2⁰)M₃(2⁰)), M(2¹) (=M₀(2¹)M₁(2¹)M₂(2¹) M₃(2¹)), M(2²) (=M₀(2²)M₁(2²)M₂(2²)M₃(2²)), and M(2³) (=M₀(2³)M₁(2³)M₂(2³)M₃(2³)) serve to shift (or advance) the current state by 2⁰, 2¹, 2², and 2³, respectively. The mask patterns M(2ⁱ) (=M₀(2ⁱ)M₁(2ⁱ)M₂(2ⁱ)M₃(2ⁱ)) for shifting the current state by 2ⁱ are input to the AND operators 10˜13. The AND operators 10˜13 perform the AND operations on the mask patterns and the current state values of the shift registers S₃, S₂, S₁, and S₀. AND operation results are sequentially buffered in the buffers R₀˜R₃ through the EXOR operator 20 and then are input again to the shift register S₀. When t₀=1, the mask pattern M(2⁰) (=M₀(2⁰)M₁(2⁰)M₂(2⁰)M₃(2⁰)) is loaded. When t₁=1, the mask pattern M(2¹) (=M₀(2¹)M₁(2¹)M₂(2¹)M₃(2¹)) is loaded. When t₂=1, the mask pattern M(2²) (=M₀(2²)M₁(2²)M₂(2²)M₃(2²)) is loaded. When t₃=1, the mask pattern M(2³) (=M₀(2³)M₁(2³)M₂(2³)M₃(2³)) is loaded. That is, when t₀=1, the AND operator10 performs the operation on the current state value of the shift register S₀ and the mask pattern M₀(2⁰), the AND operator 11 performs the operation on the current state value of the shift register S₁ and the mask pattern M₁(2⁰), the AND operator 12 performs the operation on the current state value of the shift register S₂ and the mask pattern M₂(2⁰), and the AND operator 13 performs the operation on the current state value of the shift register S₃ and the mask pattern M₃(2⁰). Similarly, when t1, t2, and t3 are 1, the operations are performed in the above-described method.

As described above, FIG. 6 illustrates the case where a state is computed after arbitrary t (=(t₃t₂ . . . t₀)₂) chips from the current state of a 4-stage LFSR. In this case, four mask patterns M(2⁰), M(2¹), M(2²), and M(2³) are successively applied to shift (or advance) the current state by 2⁰, 2¹, 2², and 2³, respectively. That is, when 0=k<4, M(2^{k}) is repeatedly applied as long as tₖ=1 with respect to all k values regardless of an order of k. This method makes a shift of t=t₀+t₁2+t₂2²+t₃2³ by dividing the shift into shifts of t₀, T₁2, t₂2², and t₃2³.

When an extension is made, there can be considered the case where a state is computed after arbitrary t (=(tₙ₋₁tₙ₋₂ . . . t₀)₂) chips from the current state of an n-stage LFSR. In this case, four mask patterns M(2⁰), M(2¹), . . . , M(2ⁿ⁻¹) are successively applied to shift (or advance) the current state by 2⁰, 2¹, . . . 2ⁿ⁻¹, respectively. That is, when 0=k<n, M(2^{k}) is repeatedly applied as long as tₖ=1 with respect to all k values regardless of order of k. This method makes a shift of t=t₀+t₁2+ . . . +tₙ₋₁2ⁿ⁻¹ by dividing the shift into shifts of t₀, t₁2, . . . ,tₙ₋₁2ⁿ⁻¹. FIG. 7 illustrates a processing operation for computing a state after arbitrary t (=(tₙ₋₁tₙ₋₂ . . . t₀)₂) chips from the current state of the n-stage LFSR.

Referring to FIG. 7, a controller (or processor) (not illustrated) stores mask patterns M(2ⁱ) (for 0≦i<n) in a table (not illustrated) in step 111. The mask patterns stored in the table are the mask patterns provided to the AND operators 10˜13 of FIG. 6. In step 112, the controller sets a time of t (=(tₙ₋₁tₙ₋₂ . . . t₀)₂) chips within a time interval of the sleep mode in order to compute a state after arbitrary t (=(tₙ₋₁tₙ₋₂ . . . t₀)₂) chips from the current state of the LFSR. In step 113, the controller set a variable i to 0. In step 114, the controller determines whether tᵢ=0. When determining that tᵢ=0 in step 114, the controller proceeds to step 118. If tᵢ≠0, the controller proceeds to step 118 after performing steps 115 to 117. In step 115, the next symbol is obtained by an associated mask pattern M(2ⁱ). If the next symbol is obtained, it means that an AND operation is performed on the associated mask pattern M(2ⁱ) and the output of the associated shift register and an AND operation result is output. In step 116, the obtained symbol is sequentially stored in the buffers R₀˜R₃ through the switch SW2 and then is provided to the LFSR through the switch SW3. In step 117, the state of the LFSR is updated. In step 119, the operation for updating the state of the LFSR is repeated until i is not less than n.

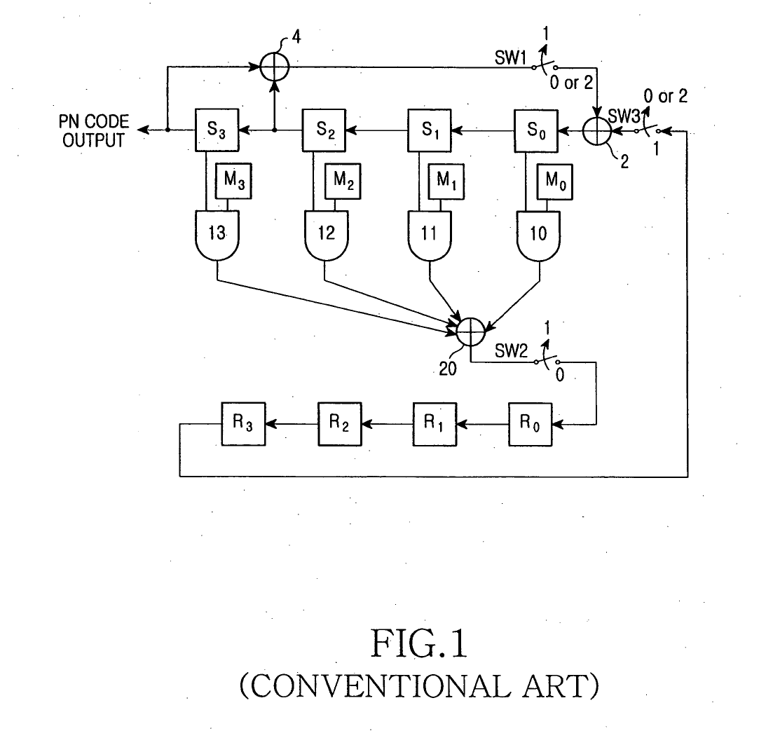

An exemplary embodiment of the present invention as illustrated in FIGS. 6 and 7 has the following effects described below. When the device of FIG. 1 uses a 4-chip advance mask pattern and applies a successive accumulation scheme like the device as illustrated in FIG. 6, it can theoretically advance a LFSR state by the number of chips corresponding to all multiples of 4. However, when the length n of the LFSR is long and the multiple is large, the device of FIG. 1 has a limitation that a mask pattern is repeatedly applied a number of times corresponding to the multiple. It can be seen that a LFSR state after an arbitrary time can be effectively computed using a minimum number of mask patterns when the device of FIG. 6 applies n different mask patterns at most n times according to a power of 2. Assuming that a state is computed in a t₂₈ chip interval, a mask pattern in the t₂₈ chip interval is selected from among mask patterns in chip intervals of t₀˜t₂₈ according to the prior art. However, an exemplary embodiment of the present invention requires 2⁴(=16) mask patterns, 2³(=8) mask patterns, or 2²(=4) mask patterns rather than 29 mask patterns according to the prior art.

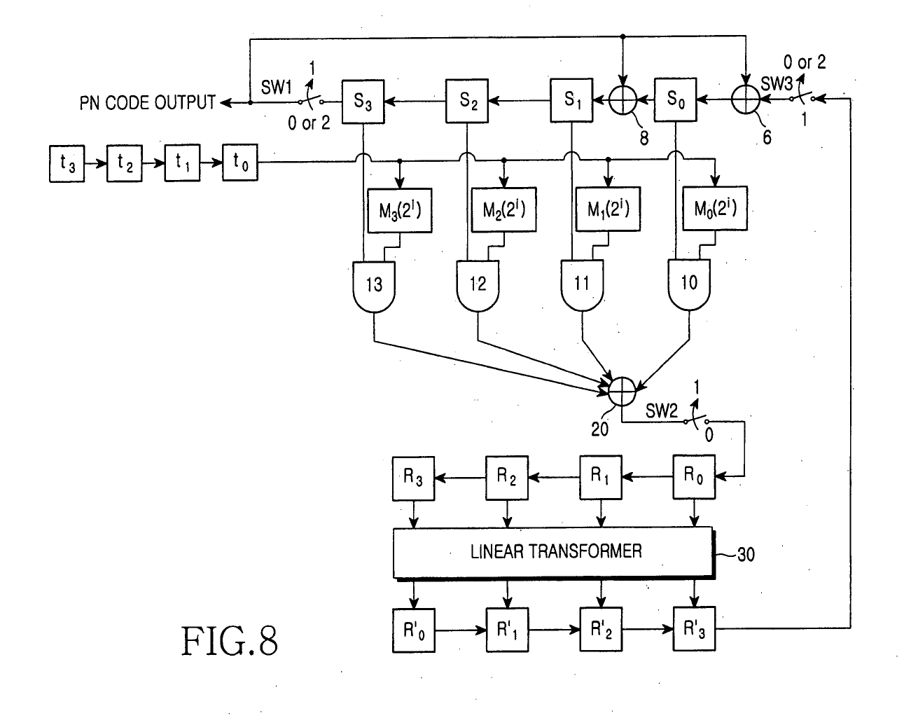

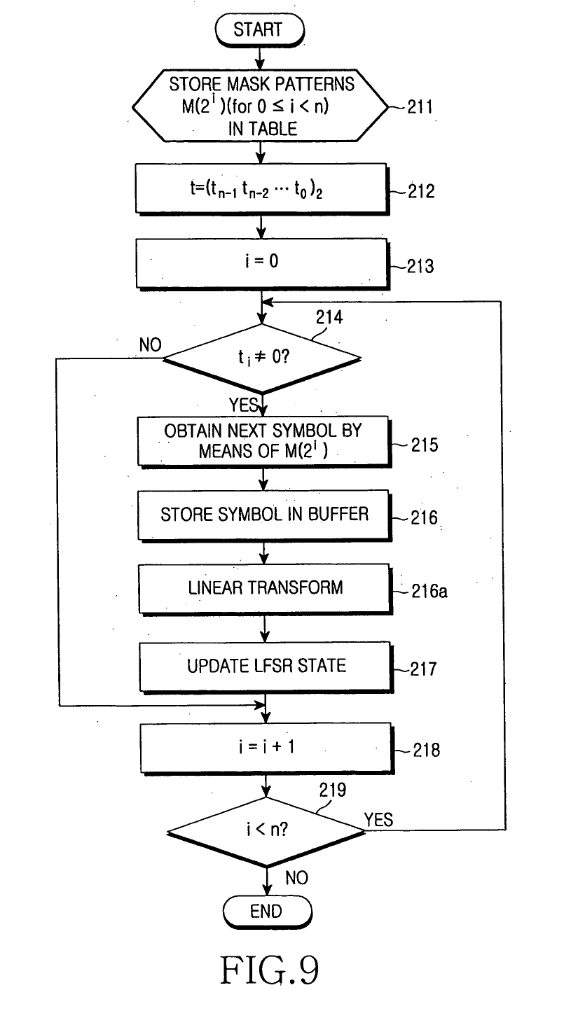

FIG. 8 is a block diagram illustrating another example of a device for computing a state of a PN generator in accordance with an exemplary embodiment of the present invention and FIG. 7 is a flowchart illustrating an example of a processing operation for computing a state in the device of FIG. 8. FIG. 8 is the block diagram illustrating the device for computing a state after an arbitrary time has elapsed by successively applying at most 4 mask patterns to a 4-stage LFSR of a Galois connection scheme. FIG. 9 illustrates an extension of the device of FIG. 8. FIG. 9 is a flowchart illustrating the processing operation for computing a state after an arbitrary time has elapsed by successively applying different mask patterns to an n-stage LFSR at most n times.

Referring to FIG. 8, the LFSR of the PN generator is provided with shift registers S₀, S₁, S₂, and S₃ and EXOR operators 6 and 8. Except for these components, the remaining components configure the device for computing a state of the PN generator.

The shift register S₀ receives an output of the EXOR operator 6 and then outputs a shifted value. The shift register S₁ receives the output of the shift register S₀ through the EXOR operator 8 and then outputs a shifted value. The shift register S₂ receives the output of the shift register S₁ and then outputs a shifted value. The shift register S₃ receives the output of the shift register S₂ and then outputs a shifted value. The output of the shift register S₃ is produced as a PN code through a switch SW1. The EXOR operator 8 receives the value output from the shift register S₀, receives the value output from the shift register S₃ through the switch SW1, performs an EXOR operation on the received values, and outputs an EXOR operation result. The output of the EXOR operator 8 is input to the shift register S₁. The EXOR operator 6 receives the output of the shift register S₃ through the switch SW1, receives an output of a buffer R′₃ through a switch SW3, and performs an EXOR operation on input values to output an EXOR operation result.

AND operators 10˜13 receive the outputs of the shift registers S₀˜S₃ and mask patterns M₀˜M₃ mapped thereto, perform AND operations on them, and output AND operation results. The AND operator 10 receives the output of the shift register S₀ and the mask pattern M₀ and performs the AND operation on S₀ and M₀ values. The AND operator 11 receives the output of the shift register S₁ and the mask pattern M1 and performs the AND operation on S₁ and M₁ values. The AND operator 12 receives the output of the shift register S₂ and the mask pattern M₂ and performs the AND operation on S₂ and M₂ values. The AND operator 13 receives the output of the shift register S₃ and the mask pattern M₃ and performs the AND operation on S₃ and M₃ values. An EXOR operator 20 receives values output from the AND operators 10˜13, performs an EXOR operation on the received values, and outputs an EXOR operation result. A buffer R₀ buffers the output of the EXOR operator 20 received through a switch SW2. A buffer R₁ receives and buffers an output of the buffer R₀. A buffer R₂ receives and buffers an output of the buffer R₁. A buffer R₃ receives and buffers an output of the buffer R₂. When all the buffers R₀, R₁, R₂, and R₃ are full, their output values are provided to a linear transformer 30.

The linear transformer 30 receives the output values of the buffers R₀, R₁, R₂, and R₃ and linearly combines the received values. Then, the linear transformer 30 provides linear combination results to buffers R′₃˜R′₀. The linear transformer 30 performs a linear combination operation immediately after a preset time (for example, 4 chips) has elapsed. An output of the buffer R′₃ is provided to one input terminal of the EXOR operator 6 through a switch SW3. State values output from the buffers R′₃, R′₂, R′₁, and R′₀ are serially provided to the shift registers S₃, S₂, S₁, and S₀ of the LFSR.

At the time of an initial operation, the switches SW1 and SW2 are closed and the switch SW3 is opened. When a preset time (for example, 4 chips) has elapsed, the switches SW1 and SW2 are switched to the opening state and the switch SW3 is switched to the closing state. When a preset time (for example, 8 chips) has elapsed, the switches SW1 and SW2 are switched to the closing state and the switch SW3 is switched to the opening state. This switching operation is repeated in a set time unit.

As a result, the mask patterns M₀˜M₃ serve to shift or advance the current state by 2⁰, 2¹, 2², and 2³, respectively. The mask patterns M₀˜M₃ are input to the AND operators 10˜13. The AND operators 10˜13 perform the AND operations on the mask patterns and the current state values of the shift registers S₃, S₂, S₁, and S₀. AND operation results are sequentially buffered in the buffers R₀˜R₃ through the EXOR operator 20. After the outputs of the buffers R₀˜R₃ are linearly combined by the linear transformer 30. The linear combination results are sequentially buffered in the buffers R′₃˜R′₀ and then are input again to the shift register S₀.

The mask patterns M(2⁰) (=M₀(2⁰)M₁(2⁰)M₂(2⁰)M₃(2⁰)), M(2¹)(=M₀(2¹)M₁(2¹)M₂(2¹)M₃(2¹)), M(2²) (=M₀(2²)M₁(2²)M₂(2²)M₃(2²)), and M(2³) (=M₀(2³)M₁(2³)M₂(2³)M₃(2³)) serve to shift (or advance) the currentstate by 2⁰, 2¹, 2², and 2³, respectively. The mask patterns M(2ⁱ) (=M₀(2ⁱ)M₁(2ⁱ)M₂(2ⁱ)M₃(2ⁱ)) for shifting the current state by 2ⁱ are input to the AND operators 10˜13. The AND operators 10˜13 perform the AND operations on the mask patterns and the current state values of the shift registers S₃, S₂, S₁, and S₀. AND operation results are sequentially buffered in the buffers R₀˜R₃ through the EXOR operator 20 and then are input again to the shift register S₀. When t₀=1, the mask pattern M(2⁰) (=M₀(2⁰)M₁(2⁰)M₂(2⁰)M₃(2⁰)) is loaded. When t₁=1, the mask pattern M(2¹) (=M₀(2¹)M₁(2¹)M₂(2¹)M₃(2¹)) is loaded. When t₂=1, the mask pattern M(2²) (=M₀(2²)M₁(2²)M₂(2²)M₃(2²)) is loaded. When t₃=1, the mask pattern M(2³) (=M₀(2³)M₁(2³)M₂(2³)M₃(2³)) is loaded. That is, when t₀=1, the AND operator 10 performs the operation on the current state value of the shift register S₀ and the mask pattern M₀(2⁰), the AND operator 11 performs the operation on the current state value of the shift register S₁ and the mask pattern M₁(2⁰), the AND operator 12 performs the operation on the current state value of the shift register S₂ and the mask pattern M₂(2⁰), and the AND operator 13 performs the operation on the current state value of the shift register S₃ and the mask pattern M₃(2⁰). Similarly, when t₁, t₂, and t₃ are 1, the operations are performed in the above-described method.

As described above, FIG. 8 illustrates the case where a state is computed after arbitrary t (=(t₃t₂ . . . t₀)₂) chips from the current state of a 4-stage LFSR. In this case, four mask patterns M(2⁰), M(2¹), M(2²), and M(2³) are successively applied to shift (or advance) the current state by 2⁰, 2¹, 2², and 2³, respectively. That is, when 0=k<4, M(2^{k}) is repeatedly applied as long as tₖ=1 with respect to all k values regardless of order thereof. This method makes a shift of t=t₀+t₁2+t₂2²+t₃2³ by dividing the shift into shifts of t₀, t₁2, t₂2², and t₃2³.

When an extension is made, there can be considered the case where a state is computed after arbitrary t (=(tₙ₋₁tₙ₋₂ . . . t₀)₂) chips from the current state of an n-stage LFSR. In this case, four mask patterns M(2⁰), M(2¹), . . . , M(2ⁿ⁻¹) are successively applied to shift (or advance) the current state by 2⁰, 2¹, . . . 2ⁿ⁻¹, respectively. That is, when 0=k<n, M(2^{k}) is repeatedly applied as long as tₖ=1 with respect to all k values regardless of order of k. This method makes a shift of t=t₀+t₁2+ . . . +tₙ₋₁2ⁿ⁻¹ by dividing the shift into shifts of t₀, t₁2, . . . tₙ₋₁2ⁿ⁻¹. FIG. 9 illustrates a processing operation for computing a state after arbitrary t (=(tₙ₋₁tₙ₋₂ . . . t₀)₂) chips from the current state of the n-stage LFSR.

FIG. 9 is a flowchart illustrating the processing operation for computing a state after an arbitrary time has elapsed by successively applying different mask patterns to an n-stage LFSR at most n times (Steps 211-219). Because the processing operation of FIG. 9 is the same as that of FIG. 7, except for a linear transform in step 216a, a description of each step is omitted for clarity and conciseness.

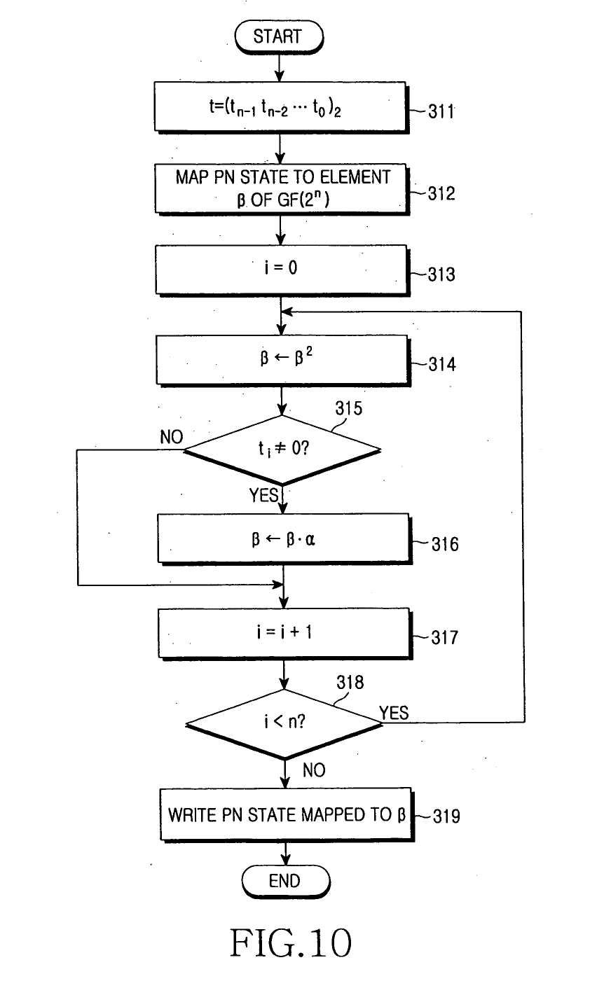

A new square & multiply algorithm for directly computing a state of a LFSR after an arbitrary time without use of mask patterns as illustrated in FIGS. 6 to 9 will be described with reference to FIGS. 10 to 13.

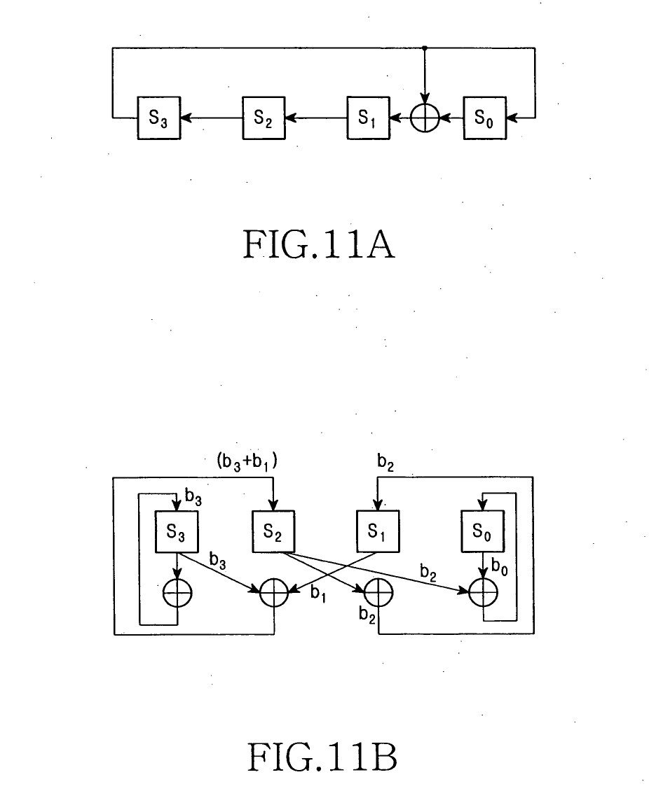

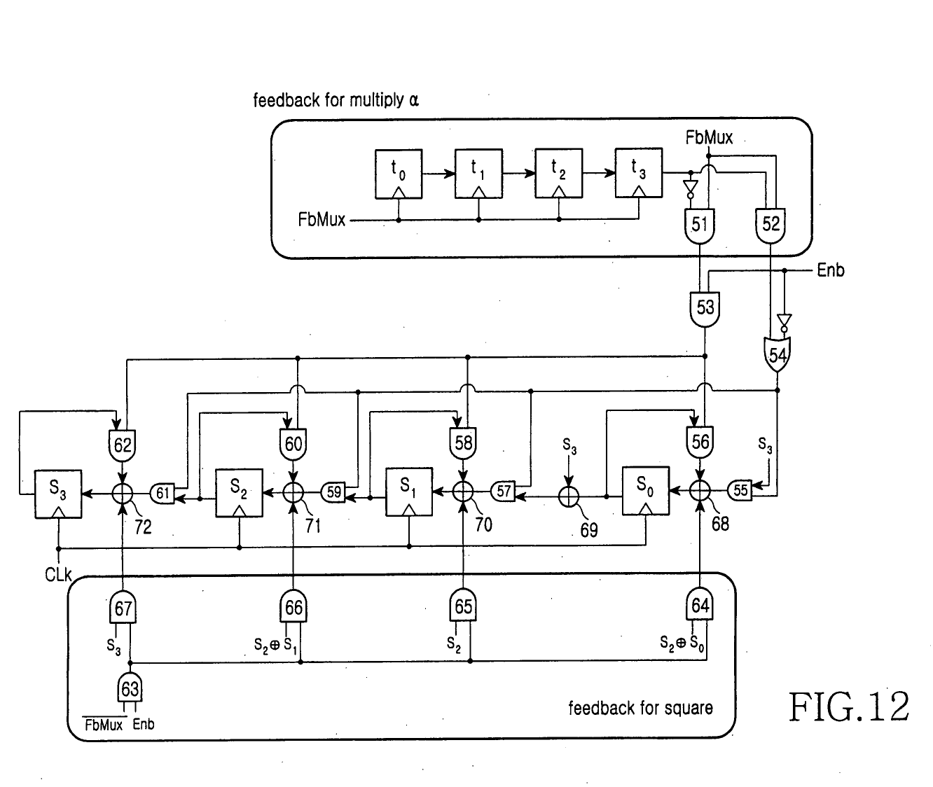

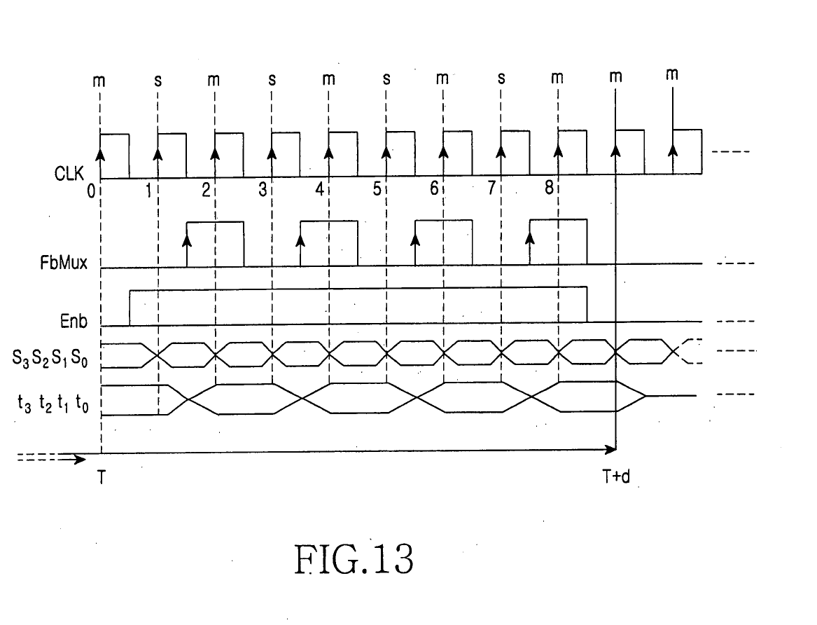

FIGS. 10 and 12 illustrate an algorithm and hardware structure that can directly compute a state of a LFSR in the square & multiply algorithm without use of mask patterns. When the algorithm of FIG. 10 is implemented by the hardware of FIG. 12, an n-stage LFSR can be quickly slewed to an arbitrary state after a shift of 2n. FIGS. 11A and 11B illustrate shift register logic structures for performing multiply and square operations when n=4. FIG. 13 is a signal timing diagram illustrating an operation for computing a state in the device of FIG. 12.

When an initial value of the n-stage LFSR connected in the Galois scheme is a non-zero value, state values output according to shifts in the LFSR are mapped to all elements except 0 of GF(2ⁿ) in one-to-one correspondence. For example, assuming that (0010) of states of the LFSR is mapped to the primitive element α when a primitive element of GF(24) is α, a state (α₃α₂α₁α₀) of the LFSR is expressed by Equation (1).
α₃α³+α₂α²+α₁α+α₀εGF(2⁴) Equation (1)

Assuming that α₃α³+α₂α²+α₁α+α₀=α^{x} in Equation (1), a state after t chips is defined as shown in Equation (2). The state after the t chips is a state after t shifts.

$$\begin{matrix}{α}^{x} {α}^{t} = {α}^{x + t} \\ = {α}^{t} ( {α}_{3} {α}^{3} + {α}_{2} {α}^{2} + {α}_{1} α + {α}_{0} α ) \\ = {α}_{3} {α}^{t + 3} + {α}_{2} {α}^{t + 2} + {α}_{1} {α}^{t + 1} + {α}_{0} {α}^{t}\end{matrix} \qquad Equation ( 2 )$$

A state after t chips in α^{x} is computed by performing linear combinations with respect to α³, α², α, and 1 in Equation (2). Equation (2) can be rewritten as Equation (3).

$$\begin{matrix}{α}^{x} {α}^{t} = {α}_{3} {α}^{i + 3} + {α}_{2} {α}^{t + 2} + {α}_{1} {α}^{t + 1} + {α}_{0} {α}^{t} \\ = {α}_{3}^{′} {α}^{3} + {α}_{2}^{′} {α}^{2} + {α}_{1}^{′} α + {α}_{0}^{′}\end{matrix} \qquad Equation ( 3 )$$

When Equation (3) is given, a′₃ α′₂ α′₁ α′₀ becomes a state after t chips in the LFSR.

For example, when t=t₀+t₁2+t₂2²+t₃2³ in a 4-stage LFSR, α^{x+1} is computed by repeatedly squaring and multiplying by α. This can be expressed as shown in Equation (4).
((((α^{x})²α′³)²α40 ²)²α′¹)²α′⁰=(α^{x})^{2′}α′=α^{x}α′ Equation (4)

In Equation (4), the second equality uses β^{2″}=β in GF(2ⁿ). Thus, Equation (4) is computed only by squaring and multiplying by α. A processing operation based on Equation (4) is illustrated in FIG. 10.

Referring to FIG. 10, a controller (or processor) (not illustrated) takes a time of t (=(tₙ₋₁tₙ₋₂ . . . t₀)₂) chips within a time interval of the sleep mode in order to compute a state after arbitrary t (=(tₙ₋₁tₙ₋₂ . . . t₀)₂) chips from the current state of the LFSR in step 311. The controller maps a PN state to an element β of GF(2ⁿ) in step 312. In step 313, the controller set a variable i to 0. In step 314, the controller replaces β² with β. In step 315, the controller determines whether tᵢ=0.

When determining that tᵢ=0 in step 315, the controller immediately proceeds to step 317. If tᵢ≠0, the controller proceeds to step 317 after performing step 316. In step 316, the controller replaces {β·α} by β. After steps 314 to 316 are performed, the controller increments i by 1 in step 317. Then, the controller again performs steps 314 to 316. This operation is performed when it is determined that i is not less than n in step 318. When determining that i is equal to or more than n in step 318, the controller writes a PN state mapped to P and ends the operation in step 319.

When t=t₀+t₁2+t₂2²+t₃2³ in a 4-stage LFSR, α′″ can be computed by repeatedly squaring and multiplying by a as shown in Equation (4). The multiply operation is the same as a result obtained by one shift in the LFSR connected in the Galois scheme. In relation to this, an example of the shift register logic is illustrated in FIG. 11A.

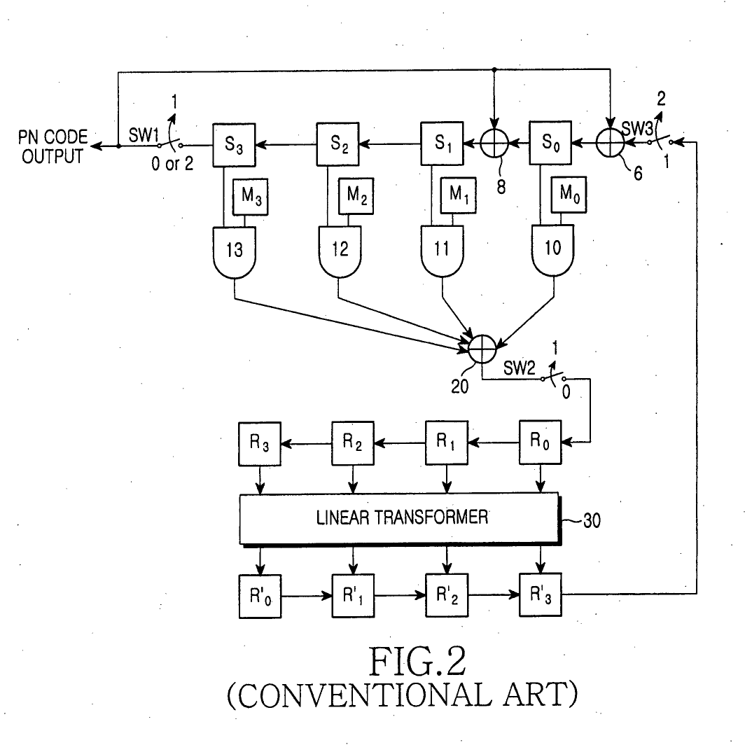

On the other hand, the square operation can be performed as follows. Assuming that a characteristic polynomial of the LFSR connected in the Galois scheme for expressing an element of GF(2⁴) is x⁴+x+1 as illustrated in FIGS. 2 and 8, a primitive element α satisfies that α^{4+α+}1=0. When β=b₃α⁶+b₂α⁴+b₁α²+b₀ for b₁=0,1, β² can be expressed by a characteristic 2 finite field as shown in Equation (5).

$$\begin{matrix}{β}^{2} = {( {b}_{3} {α}^{3} + {b}_{2} {α}^{2} + {b}_{1} α + {b}_{0} )}^{2} \\ = {b}_{3} {α}^{6} + {b}_{2} {α}^{4} + {b}_{1} {α}^{2} + {b}_{0}\end{matrix} . \qquad Equation ( 5 )$$

In Equation (5), the first equality is (b₃α³)²+(b₂α²)²+(b₁α)² +(b₀)². Because b₃, b₂, b₀, or b₀ has a value of 0 or 1, the second equality is obtained. Because α⁶=α³+α² and α^{4 l =α+}1, Equation (5) can be rewritten as Equation (6). An example of implementing Equation (6) with the shift register logic is illustrated in FIG. 11B.
β²=b₃α³+(b₃+b₁)α²+b₂α+(b₂+b₀) Equation (6)

α^{x}α¹=((((α^{x})²α′³)²α′²)²α′¹)²α′⁰ as shown in Equation (4) can be implemented by repeatedly applying the square and multiply operation as illustrated in FIGS. 11A and 11B. In relation to this operation, an example of computing a state of the LFSR is illustrated in FIG. 12. Operation timing in the device of FIG. 12 is illustrated in FIG. 13.

Referring to FIG. 12, it can be seen that a 4-stage LFSR is provided with shift registers S₀, S₁, S₂, and S₃. The shift register S₀ receives an output of an EXOR operator 68 and outputs a value in response to a clock CLK. The EXOR operator 68 receives outputs of AND operators 55, 56, and 64 and performs an EXOR operation on them to output an EXOR operation result. The AND operator 55 receives an output of an OR operator 54 and an output of the shift register S₃ and performs an AND operation on them to output an AND operation result. The AND operator 56 receives an output of an AND operator 53 and an output of the shift register S₀ and performs an AND operation on them to output an AND operation result. The AND operator 64 receives a result of EXORing the outputs of the shift registers S₀ and S and an output of an AND operator 63 and performs an AND operation on them to output an AND operation result. The AND operator 63 receives an enable signal Enb and an inverted selection signal F̅b̅M̅u̅x̅ and performs an AND operation on them to output an AND operation result. An EXOR operator 69 receives the outputs of the shift registers S₀ and S₃, and performs an EXOR operation on them to output an EXOR operation result. An AND operator 57 receives the output of the EXOR operators 69 and the output of the OR operator 54 and performs an AND operation on them to output an AND operation result. An EXOR operator 70 receives outputs of AND operators 57, 58, and 65 and performs an EXOR operation on them to output an EXOR operation result. The AND operator 58 receives the output of the shift register S₁ and the output of the AND operator 53 and performs an AND operation on them to output an AND operation result. The AND operator 65 receives the output of the shift register S₂ and the output of the AND operator 63 and performs an AND operation on them to output an AND operation result.

The shift register S₁ receives the output of the EXOR operator 70 and outputs a value in response to the clock CLK. An AND operator 59 receives an output of the shift register S₁ and the output of the OR operator 54 and performs an AND operation on them to output an AND operation result. An EXOR operator 71 receives outputs of AND operators 59, 60, and 66 and performs an EXOR operation on them to output an EXOR operation result. The AND operator 60 receives the output of the shift register S₂ and the output of the AND operator 53 and performs an AND operation on them to output an AND operation result. The AND operator 66 receives a result of EXORing the outputs of the shift registers S₁ and S₂ and an output of the AND operator 63 and performs an AND operation on them to output an AND operation result.

The shift register S₂ receives an output of the EXOR operator 71 and outputs a value in response to the clock CLK. An AND operator 61 receives the output of the shift register S₂ and the output of the OR operator 54 and performs an AND operation on them to output an AND operation result. The EXOR operator 72 receives outputs of AND operators 61, 62, and 67 and performs an EXOR operation on them to output an EXOR operation result. The AND operator 62 receives the output of the shift register S₃ and the output of the AND operator 53 and performs an AND operation on them to output an AND operation result. The AND operator 67 receives the output of the shift register S₃ and the output of the AND operator 63 and performs an AND operation on them to output an AND operation result. The shift register S₃ receives an output of the EXOR operator 72 and outputs a value in response to the clock CLK.

The AND operator 53 receives an output of an AND operator 51 and the enable signal Enb and performs an AND operation on them to output an AND operation result. The OR operator 54 receives the output of the AND operator 52 and the inverted enable signal and performs an OR operation on them to output an OR operation result. The AND operator 52 receives the selection signal FbMux and an output of a flip-flop t₃ and performs an AND operation to output an AND operation result. The AND operator 51 receives the selection signal FbMux, receives the output of the flip-flop t₃ passing through an inverter, and performs an AND operation to output an AND operation result. Serially connected flip-flops t₃, t₂, t₁, and to operate in response to the selection signal FbMux.

The AND operators 63˜67 are the components for performing the square operation. The flip-flops t₃, t₂, t₁, and t₀ and the AND operators 51 and 52 are the components for performing the multiply operation.

Referring to FIGS. 12 and 13, the enable signal Enb enables the square and multiply operations and the selection signal FbMux selects the square or multiply operation. That is, when the enable signal Enb=1, the square and multiply operations of Equation (4) are performed. When the selection signal FbMux=0, the square operation is performed. When the selection signal FbMux=1, the multiply operation is performed. The multiply operation differs according to a value of t₁. That is, an operation for multiplying by 1 is performed when t₁=0, and an operation for multiplying by a is performed when t₁=1. In the n-stage LFSR, the square and multiply operations require a fixed {2n}-chip time. If the fixed {2n}-chip time is required, it means that a number of shifts mapped to the required time are required. For example, 8 shifts are required to perform the square and multiple operations in the 4-stage LFSR as illustrated in FIG. 12. Eight pulses are required in the clock CLK. When this is used for the slew operation, a fixed computation delay is pre-added to t.

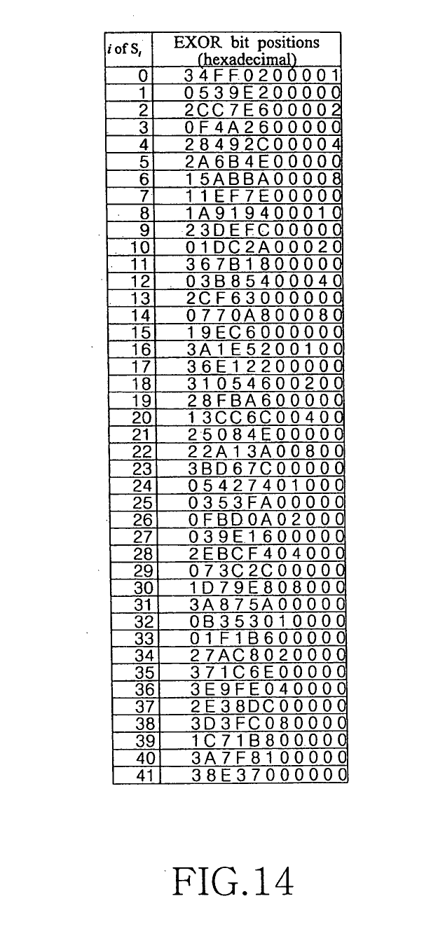

A LFSR can be implemented in accordance with an exemplary embodiment of the FIGS. 10 to 13. This LFSR can be applied to a cdma2000 system, a Universal Mobile Telecommunications System (UMTS) (or Wide-band CDMA (WCDMA)) system, and the like as illustrated in FIGS. 14 to 16 as described below.

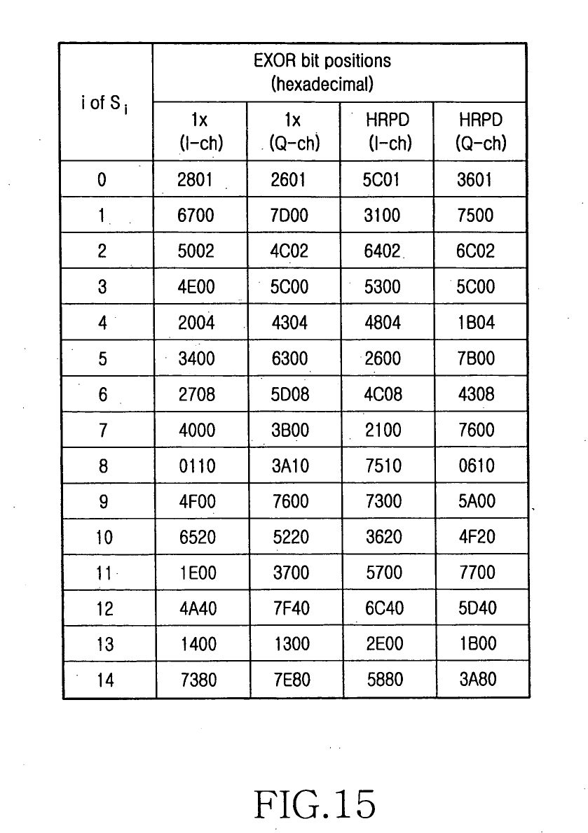

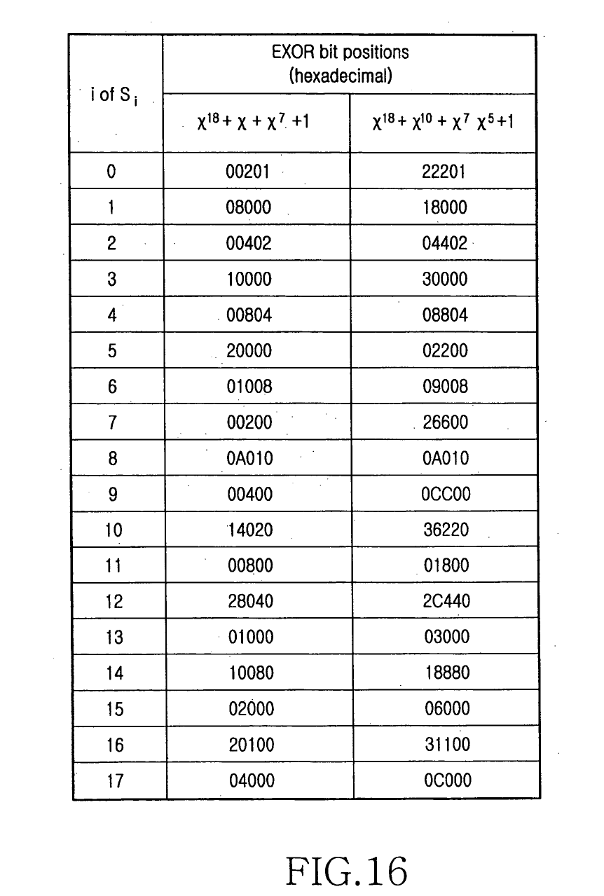

FIGS. 14 to 16 illustrate linear combination functions fed back to shift registers when the square operation is performed in the device of FIG. 12. FIG. 14 illustrates a table obtained by expressing the linear feedback logic in the form of hexadecimal numbers with respect to the square operation of the LFSR for generating a long code. FIG. 15 illustrates a table obtained by expressing the linear feedback logic in the form of hexadecimal numbers with respect to the square operation of the LFSR for generating a short code of an I/Q channel in a cdma2000 1× or High Rate Packet Data (HRPD) system. FIG. 16 illustrates a table obtained by expressing the linear feedback logic in the form of hexadecimal numbers with respect to the square operation of the LFSR for generating two m-sequences that configures a downlink scrambling code generator in a WCDMA system proposed in 3rd Generation Partnership Project (3GPP).

FIG. 14 illustrates a linear combination finction input to each shift register S₁ for the square operation in a cdma200 long-code sequence generator with a characteristic polynomial p(x) as shown in Equation (7).
S′₂₂=S₄₁+S₃₇+S₃₅+S₃₃+S₂₈+S₂₅+S₂₄+S₂₃+S₂₁+S₁₁ Equation (7)

For example, because a connection to S₂₂ is (22A13A00800)₁₆ in FIG. 14, previous register values mapped to a position of 1 are input when S′₂₂ corresponding to a new state of S₂₂ is expressed by a binary number. S′₂₂ can be defined as shown in Equation (8)
S′₂₂=S₄₁+S₃₇+S₃₅+S₃₃+S₂₈+S₂₅+S₂₄+S₂₃+S₂₁+S₁₁ Equation (8)

As described above, exemplary embodiments of the present invention proposes a method and apparatus that can quickly and efficiently compute an LFSR state after an arbitrary time. The present invention can compute the next state of a PN generator in sleep/idle mode or can be applied to a slew operation of the PN generator at the time of a handover or multipath combining of a searcher or finger.

When a high-speed slew operation can be performed, the acquisition performance of a terminal can be improved. Exemplary embodiments of the present invention can reduce a computation time of the PN generator in the sleep/idle mode, thereby reducing a wake-up time of a Central Processing Unit (CPU) and related components and therefore reducing power consumption.

Conventionally, a discontinuous reception scheme is mandatory to reduce power consumption in a mobile termninal. As an amount of transmission data increases and a frequency band is high, an operating rate of a searcher or finger is required to be improved. Therefore, exemplary embodiments of the present invention improves the operating rate of components, thereby reducing the power consumption of the terminal and improving the reception performance of the terminal.

The present invention can also be embodied as computer-readable codes on a computer-readable recording medium. The computer-readable recording medium is any data storage device that can store data which can thereafter be read by a computer system. Examples of the computer-readable recording medium include, but are not limited to, read-only memory (ROM), random-access memory (RAM), CD-ROMs, magnetic tapes, floppy disks, optical data storage devices, and carrier waves (such as data transmission through the Internet via wired or wireless transmission paths). The computer-readable recording medium can also be distributed over network-coupled computer systems so that the computer-readable code is stored and executed in a distributed fashion. Also, function programs, codes, and code segments for accomplishing the present invention can be easily construed as within the scope of the invention by programmers skilled in the art to which the present invention pertains.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for generating a code for a communication system comprising an n-stage Linear Feedback Shift Register (LFSR), the method comprising:
expressing a characteristic polynomial indicative of current state values of an LFSR by elements of a finite Galois field;
expressing the characteristic polynomial by a finction of a primitive element of the Galois field;
computing a characteristic polynomial at an arbitrary time variably set from the characteristic polynomial expressed by the finction of the primitive element; and
repeating a multiply operation and a square operation on the characteristic polynomial computed at the arbitrary time and generating a code with a new state value by providing the new state value of the LFSR.

2. The method of claim 1, further comprising combining current state values of a LFSR and n different mask patterns to shift the current state values by {2⁰,2¹, . . . ,2ⁿ⁻¹}.

3. The method of claim 1, further comprising providing a combination result as a new state value of the LFSR at an arbitrary time variably set in the sleep mode.

4. The method of claim 2, wherein the LFSR comprises a Fibonacci connection structure.

5. The method of claim 2, wherein the LFSR comprises a Galois connection structure.

6. An apparatus for generating a code for a communication system operating in sleep mode and active mode set at a preset time interval from the sleep mode, the apparatus comprising:
an n-stage Linear Feedback Shift Register (LFSR); and
a combination logic for combining current state values of the LFSR and n different mask patterns to shift the current state values by {2⁰,2¹, . . . ,2ⁿ⁻¹}, and providing a combination result as a new state value of the LFSR at an arbitrary time variably set in the sleep mode.

7. The apparatus of claim 6, wherein the combination logic comprises a Fibonacci connection.

8. The apparatus of claim 6, wherein the combination logic comprises a Galois connection.

9. A method for generating a code for a communication system comprising an n-stage Linear Feedback Shift Register (LFSR), and operating in sleep mode and active mode set at a preset time interval from the sleep mode, the method comprising:
combining current state values of a LFSR and n different mask patterns to shift the current state values by {2⁰,2¹, . . . ,2ⁿ⁻¹}; and
providing a combination result as a new state value of the LFSR at an arbitrary time variably set in the sleep mode.

10. The method of claim 9, wherein the LFSR comprises a Fibonacci connection structure.

11. The method of claim 9, wherein the LFSR comprises a Galois connection structure.

12. A computer-readable medium storing computer-readable codes for performing a method for generating a code for a communication system comprising an n-stage Linear Feedback Shift Register (LFSR), the method comprising:
expressing a characteristic polynomial indicative of current state values of an LFSR by elements of a finite Galois field;
expressing the characteristic polynomial by a function of a primitive element of the Galois field;
computing a characteristic polynomial at an arbitrary time variably set from the characteristic polynomial expressed by the function of the primitive element; and
repeating a multiply operation and a square operation on the characteristic polynomial computed at the arbitrary time and generating a code with a new state value by providing the new state value of the LFSR.

13. The method of claim 12, further comprising combining current state values of a LFSR and n different mask patterns to shift the current state values by {2⁰,2¹, . . . ,2ⁿ⁻¹}).

14. The method of claim 12, further comprising providing a combination result as a new state value of the LFSR at an arbitrary time variably set in the sleep mode.

15. The method of claim 13, wherein the LFSR comprises a Fibonacci connection structure.

16. The method of claim 13, wherein the LFSR comprises a Galois connection structure.
